(19) United States
(12) Patent Application Publication
(10) Pub. No.: US 2008/0195495 A1
(43) Pub. Date: Aug. 14, 2008

(54) Notebook system

(76) Inventors: Robert Victor Rubin, Sharon, MA (US); Eric James Golin, Newton, MA (US)

Correspondence Address: Eric J. Golin, 178 Prince Street, West Newton, MA, 02465, US

(21) Appl. No.: 12/148,106

(22) Filed: Apr. 16, 2008

Related U.S. Application Data
(62) Division of application No. 11/052,184, filed on Feb. 7, 2005.
(60) Provisional application No. 60/542,751, filed on Feb. 6, 2004.

(51) Int. Cl. G06F 17/30; G06Q 30/00

(52) U.S. Cl. 705/14; 707/102; 707/E17.032

(57) ABSTRACT

The present invention describes a method and system for an electronic notebook that allows the user to collect, organize, annotate and share information. The notebook information consists of a collection of links to other objects such as web pages, computer files and email messages. The notebook allows the user to annotate the links with additional information such as notes, comments, highlights and other annotations. The information within the notebook can be further organized into a hierarchical set of folders. The user accesses the notebook through a user interface to view, edit, reorganize or otherwise modify the notebook. By storing the electronic notebook on a server accessed across a network, the user is able to access the information in the notebook system from multiple computers. Further, the notebook can be shared among different users, with appropriate control to allow them access to the notebook. In another aspect of the present invention, the Notebook System can be as a mechanism for delivering information, including advertising and product support, from retailers, merchants, and other enterprises to consumers and other end-users.

### CROSS-REFERENCE TO RELATED APPLICATIONS

This application claims the benefit of PPA Ser. No. 60/542,751 filed 2004 Feb. 2006 by the present inventors.

### FEDERALLY SPONSORED RESEARCH

Not Applicable

### SEQUENCE LISTING OR PROGRAM

This application contains a computer listing of an embodiment of the invention, included as an appendix on the accompanying CD-R. Two identical copies of the CD-R, labeled “Notebook System—CD 1” and “Notebook System—CD 2” have been included. Each CD-R is formatted to be read on a PC running Microsoft Windows. Each CD-R consists of two folders: the Services folder contains source code in WSDL (XML) format and C# programs (.cs) specifying the interfaces to the web services implementing the invention; and the ArgoNotebookSystem folder containing the C# (.cs) files implementing these web services. The computer listing on these disks is copyrighted by Argo Technology, Inc.

### TECHNICAL FIELD

The present invention relates to the use of computer systems to facilitate the intelligently help a user to gather, manage and utilize information from a networked collection of diverse information sources.

### BACKGROUND OF THE INVENTION

### Prior Art

Previous systems for managing collections of web pages fall into three major categories: (i) web pages containing links and annotations; (ii) Pathing Systems; and (iii) Collection Systems.

(i) Web pages containing links and annotations. Users, webmasters, and the like frequently collect links/url's to related sets of pages, encode them in HTML, attach a title such as Favorites, and publish them on the web. Pages with links on them are simple to use, and provide a launching point for users to navigate to relevant places on the web. Although links pages provide coherency to a topic, search engines, such as Google, use the link-text that describes the url, in its relevancy ranking, encouraging the creation of link farms, pointing to related pages, and polluting their value. While simple in construct, these pages are difficult to use in navigation, cannot be modified by anybody other than the author, and lack annotation support.

(ii) Pathing Systems. V. Bush, in his seminal paper envisioning the internet published in July of 1945 (O) envisioned a system whereby authors could create “paths”, that is a directed navigational framework that allowed online curriculums to be assembled, and navigation to be self-contained within those curriculums. Many authors have attempted to improve on this grand vision, including N, P, Q, R, S, U, and V. These systems can lack direct navigation, the ability to reorganize sets of links, and to allow multiple participants to add links to the system.

(iii) Collection Systems. Other systems, including B, J, R, M, and T, allow for annotation of web pages, with storage of that information on a server, or a client, where navigation and annotation are mixed together. These systems lack the ability to operate on either a server or a client, for users to share annotations with limited sets of other users (e.g. buddy lists), and for allowing authors to control the read/write access annotation privileges to those collections.

Advertising systems A, B, C, D rely on keywords, bidding mechanisms, or general user context to display a paid search result in response to a keyword query. These systems provide search results that are either relevant to the page being viewed, or to the keyword search term that is entered. Personal search systems return results based on previous context, E, F, G, or a set of rules H, or meta documents associated with an overall document set to define a user profile I, J, K, L. These systems lack the ability to use a single collection of documents into which a user and his collaborators explicitly share and exchange information, to provide a the basis for generating advertising, or the collection system itself as a basis for building a set of relevant advertising.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention facilitates information research by helping a user to gather, manage and utilize information from a networked collection of diverse information sources. The invention describes a method and system that provides the following:

A Notebook System for allowing the user to collect, organize and annotate information.

An Architecture to manage a diverse, distributed set of information sources and make them available to the user.

A Desktop Agent which integrates the notebook system with the user's desktop information.

An aspect of the present invention is the Notebook concept, which provides for allowing a user to gather together into a notebook a collection of links to other information objects such as web pages, computer files and email messages. The notebook allows the user to store information such as notes, comments, highlights and other annotations which the user may have authored associated with the individual links in the notebook. The information within the notebook can be further organized into a hierarchical set of folders. The user can access the notebook through a user interface to view, edit, reorganize or otherwise modify the information within it.

Another aspect of the notebook system is that by storing the notebook on a server accessed across a network, the user is able to access the information in the notebook system from multiple computers. Further, the notebook can be shared among different users, with appropriate control to allow them access to the notebook.

In another aspect of the present invention, the Notebook System can be used to provide a mechanism for delivering information, including advertising and product support, from retailers, merchants, and other enterprises to consumers and other end-users. Because users of the Notebook System are engaged in information gathering, they are often good targets for advertising. The invention includes several novel aspects related to advertising:

The context information from the user's notebook can be used to influence which Ads are shown to the end-user.

The Notebook System provides new mechanisms for where Ads are shown to the user.

The Notebook System supports several novel types of advertisements, providing new mechanisms for what is an advertisement.

### BRIEF DESCRIPTION OF THE DRAWINGS

FIG. 1 shows the overall organization of the Notebook system with respect to its environment.

FIG. 2 shows the high-level software architecture of the Notebook system.

FIG. 3 is a block diagram of the services within the Notebook system.

FIG. 4 shows how the Notebook is shared across computers and/or users.

FIG. 5 shows a subset of a database design for implementing the Notebook Repository using an RDBMS.

FIG. 6 shows an example of a User Interface application for the Notebook System that is browser-based and uses an add-in component called the Argo Explorer.

### DETAILED DESCRIPTION

The present invention relates to systems and methods providing for the gathering, managing and utilizing of electronic information. Information of various types is available from a variety of different sources, including many which are connected together in a network or network of networks such as the Internet or World-Wide-Web. The present invention provides a Notebook system that helps a user in collecting, organizing and annotating information.

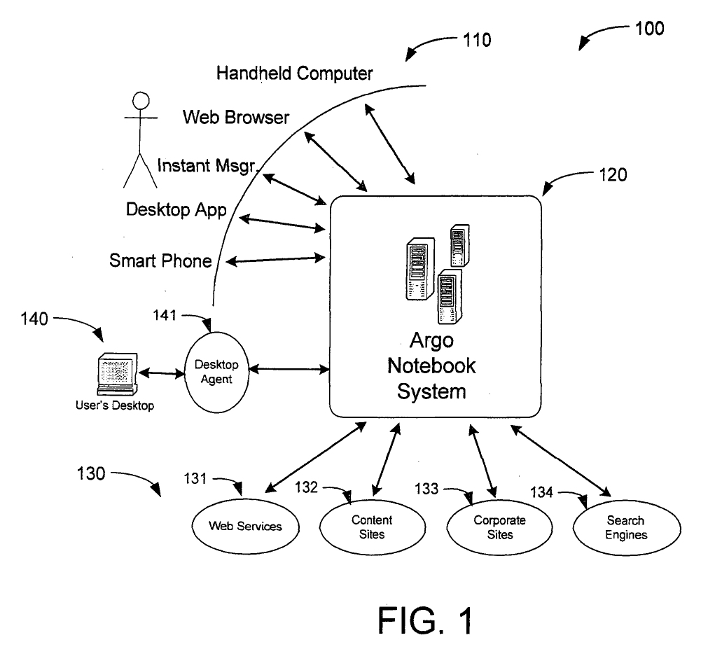

The overall environment of the Notebook system is shown in FIG. 1. The system 100 illustrates gathering, managing and utilizing information in an electronic Notebook in accordance with an aspect of the present invention. The system 100 includes one or more user interfaces 110 that allow the user to view, edit, reorganize and otherwise modify the information contained within the Notebook system 120. The Notebook system 120 can manage a diverse, distributed set of information sources 130 and make them available to the user. A Desktop Agent 141 integrates the user's desktop information, such as computer files and electronic mail messages stored on the User's Desktop 140, with the Notebook System 120.

The information within the Notebook System 120 is organized into a hierarchical set of folders. Within the folders are stored links to other information objects such as web pages from internet Content Sites 132 or intranet Corporate Sites 133; access to Web Services 131; results from Search Engines 134; or computer files and email messages on the User's Desktop 140.

Stored with the links to information objects is additional information, including text notes created by the end-user; comments on the link; data specifying highlighted sections of the referenced object; and other annotations, including multimedia objects such as audio commentary.

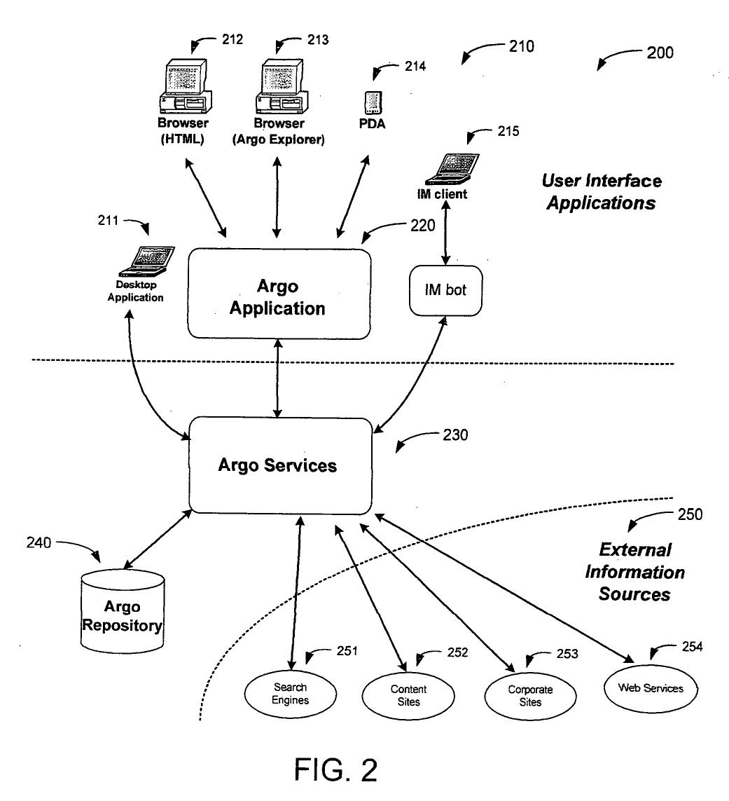

Referring to FIG. 2, the architecture of an embodiment of the Notebook System 200 is shown. The overall structure of the system consists of one or more applications 210 that provide a user interface for the system; a set of system services 230 that provide the underlying capabilities of the system; a repository 240 for the notebooks and other information in the system; and encapsulation of external information sources 250 that are accessed by the system.

The user interface applications 210 can take multiple forms, including browser-based web applications 212 and 213; desktop applications 211; applications running on specialized mobile devices such as Personal Digital Assistants (PDAs) 214; and special purpose applications such as Instant Message clients 215. In the case of some user interfaces such as desktop applications 211, the application integrates directly with the system services 230 via a network interfaces such as SOAP. For browser-based user interfaces 212 and 213, the UI integrates through a Web Application 220 that connects to the system services 230. The Web Application 220 can either generate information in a format such as HTML that can be displayed directly by the browser 212, or information in a structured format such as XML that can be interpreted and displayed by a browser plug-in such as the Argo Explorer 213.

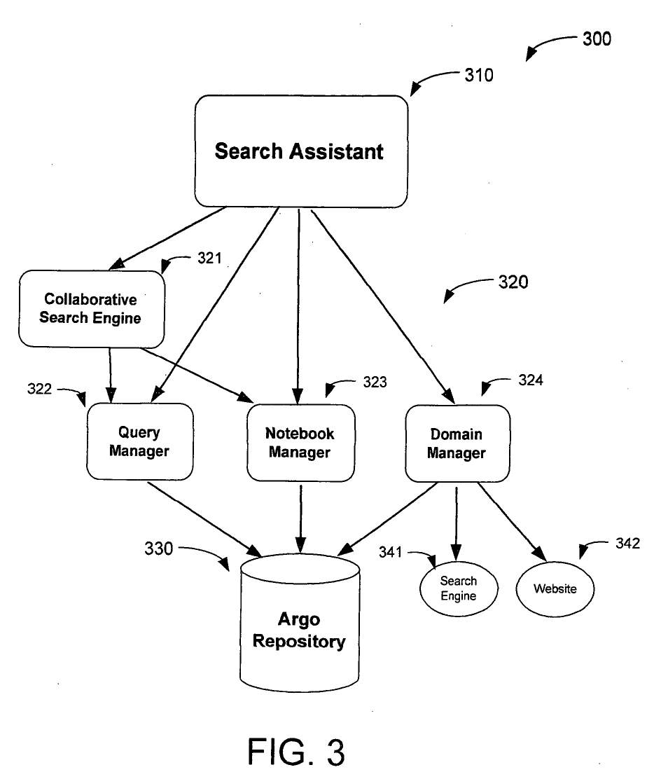

Referring to FIG. 3, the system is divided into the application component, called the Search Assistant 310, a set of Argo Services 320, the Repository 330 which stores the system information in a database, and the external information sources 3411 and 342. The Search Assistant 310 is the application that provides the user with the functions for interacting with the Notebook System. These functions include:

Creating a new folder in the notebook

Saving a link to an information object such as a web page

Reorganizing the folders and/or links saved within the notebook

Deleting a link or folder

Adding a text note or other annotation to a link

Following a Link to display the web page, file, message or other object that is referenced.

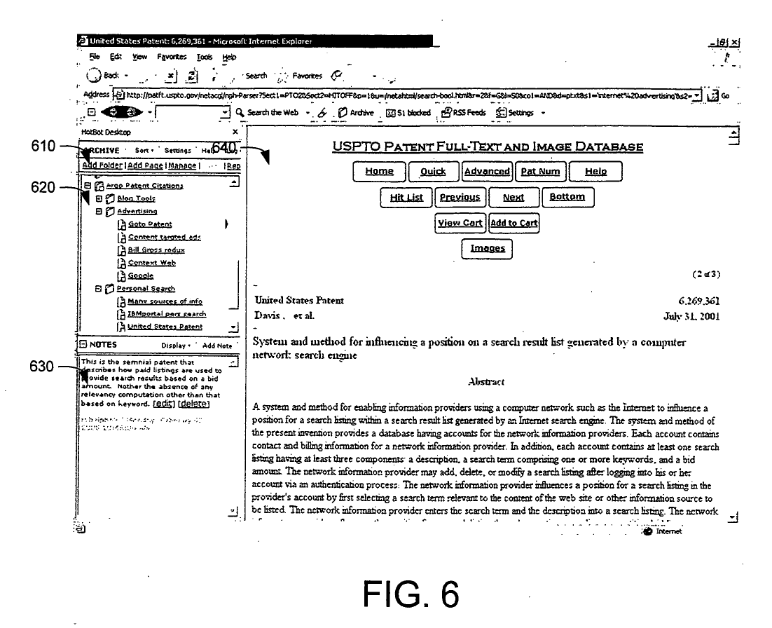

FIG. 6 shows an embodiment of the Search Assistant application in a web browser using the Argo Explorer. The application includes buttons 610 providing commands to create folders and links; a tree 620 displaying the contents of the notebook organized as hierarchical folders; a textual note 630 associated with the currently selected saved link; and the display 640 of the page referenced by the currently selected link.

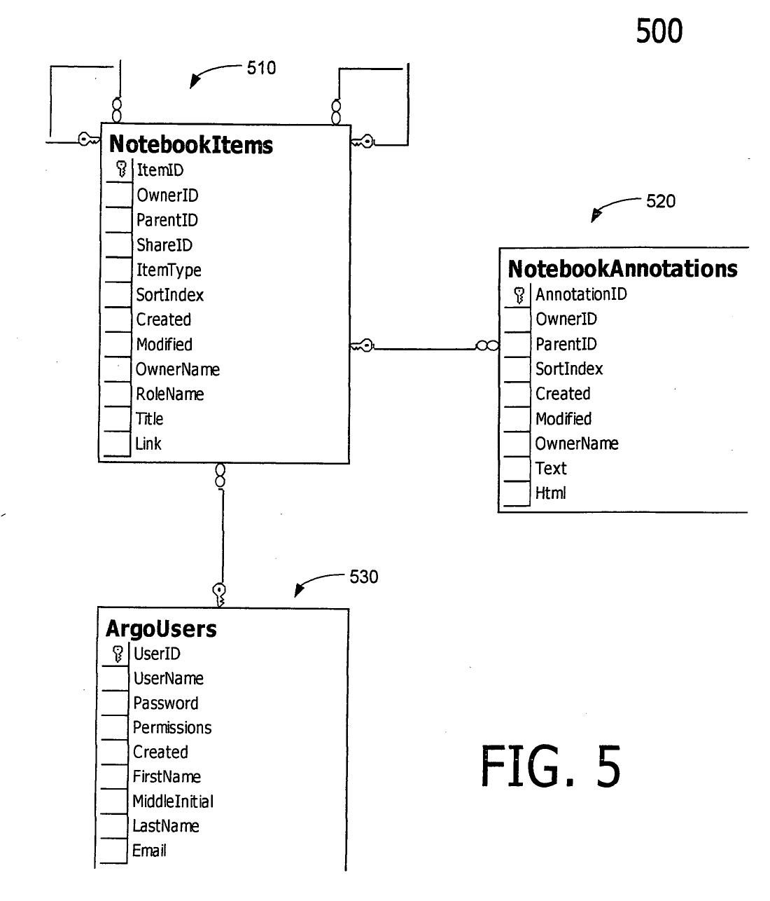

The Notebook Manager 323 provides the functions to manipulate the information contained in a Notebook as stored in the Repository 330. The Notebook Manager 323 allows the Search Assistant application 310 to create, edit and delete folders, notebooks and annotations. The Notebook Manager 323 implements these operations by mapping them to operations on the storage mechanism of the Repository 330. The Repository 330 will typically be implemented with a relational database management system. FIG. 5 shows a portion of a database schema for an embodiment of the Repository within such an RDBMS. It includes tables to hold the Notebook Items 510, which are both folders and links; the Notebook Annotations 520; and the users 530 of the Notebook System.

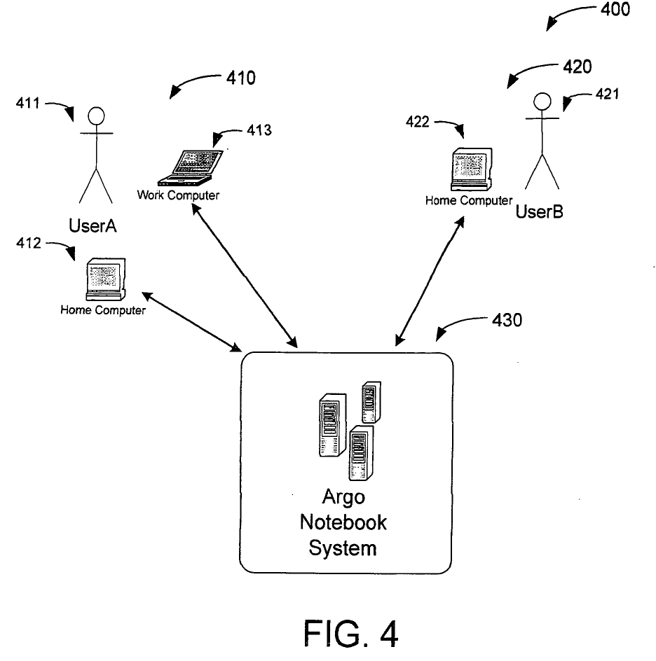

A key aspect of the notebook system is that the notebooks are stored on a server, which allows sharing of notebooks, both across multiple computers used by the same user to access the Notebook System, and between different users. Referring to FIG. 4, User A 411 has created one or more notebooks in the Notebook System 430. User A 411 can access the same notebooks in the same fashion from either his home computer 412 or his work computer 413. In addition User A 411 can share some or all of his notebooks with User B 421, who can access those shared notebooks from yet another computer 422.

The system includes a Domain Manager 324 which provides an abstract representation of an information source that is available on a network and can be referenced through a network interface, such as a search engine 341, web site 342, or local file. This abstraction may include:

Abstract representation of an information store available on a network.

How to access the information source

How to query the information source

What kind of information the source has

The ability to Automatically/semi-automatically/manually search appropriate domains for an information request.

A simple example of a domain is the wrapping of a search engine interface. A more complex Domain can be realized by building a list of top level URL's (internet domains) that the user wants to search for a particular topic area. For example, the user may have discovered that the sites www.dogs.com, www.dog-lovers.com, and www.breeders.net contain the best information about dogs, and can define a Domain that specifies that only those three sites should be searched. The user may then invoke searches on that domain whenever information on dogs is being sought. Another example of a complex domain would be a subscription medical journal which requires a username and password to access. The Domain definition can hold the access information and automate to allow the user to search the site (provided he is a subscriber). Finally, even more complex domains can be created by combining multiple domains.

Another key aspect of the system is that it can use information about the user's notebooks and searching history to improve the results of searching The Query Manager service 322 can automatically save the results of a query into the notebook system.

A powerful aspect of keeping the notebook information on a centralized server is that it allows information from one user to be used to help improve results for another user. For example, if John has a notebook that is analyzed to determine that the topic of the notebook is “Dogs:Spaniels:Breeders”, and Sally is building a Dogs notebook and does a query on “Spaniel Breeders”, the links that John has selected to save in his notebook are highly relevant to Sally's query. The Collaborative Search Engine 321 provides the ability to match against other user's queries/notebooks to find other folders with “relevant” results and return links from those. The analysis of notebooks to find “similar” and “relevant” results can be performed using standard statistical clustering analysis techniques.

The Notebook System 300 can provide a number of mechanisms to alert the user to new or additional information that is available. These can include a visual cue such as bolding, highlighting or an image or icon to indicate to the user that a link has an annotation that is new or has been modified. In addition, the system can periodically poll the pages referred to by saved links within the user's notebook and alert the user if one of those pages has been updated. For example, the user might have created a notebook entry for the products page for a company, to be alerted if there are any changes to the product descriptions.

The system can A standard technique such as hashing [is reference needed?] can be used to minimize the amount of data that needs to be stored to determine if a page has been changed. A more sophisticated algorithm such as shingling can be used to provide a more flexible measure of document change. The pages/documents referenced can be pre-processed to remove information not considered significant, such as formatting, date/timestamps and advertisements.

The system can also provide a mechanism to alert the user when additional information is available about the web page he is currently visiting within the browser. This is accomplished by providing a visual indication, such as a flashing icon on a toolbar, that tells the user that there are notes available for the current webpage. The notes can be found in one of the user's notebooks, another user's notebook that is shared with this user, or a publicly shared notebook.

In another aspect of the present invention, the Notebook System can be used to provide a mechanism for delivering information, including advertising and product support, from retailers, merchants, and other enterprises to consumers and other end-users. Because users of the Notebook System are engaged in information gathering, they are often good targets for advertising. The invention includes several novel aspects related to advertising:

The Notebook System provides new mechanisms for where Ads are shown to the user.

The Notebook System supports several novel types of advertisements, providing new mechanisms for what is an advertisement.

In typical consumer web search systems, ads are shown to the end-user along with results from a crawler-based search engine, in response to a query from the user (for example, as “sponsored links”). The Notebook system provides several novel mechanisms for where advertisements can be shown to users. Ads can be shown after the user does a search of something other than a web search, such as a search through the contents of a notebook, or a search through a specified domain.

The notebook system can also be used to present Ads to the user when he is browsing the content in a notebook rather than searching. The context provided by the Notebook and the user's interaction with it provides the basis for selecting a relevant advertisement to display to the user. Several mechanisms can be used for this selection. The simplest mechanism is to analyze the content of the notebook to produce an interest vector that characterizes the topic of the notebook, and use the interest vector to “synthesize” a keyword to match against the ad database. The notebook content can be analyzed using standard lexical techniques, such as computing a term frequency index for each element of the notebook. These values can be combined based on proximity to the element with the user's focus to form a keyword set to use for advertising selection. This mechanism can be enhanced by use of a dictionary of search terms with associated weights (for example, the list of keywords on which merchants have bid to place ads along with value of the winning bids). By matching the terms from the notebook with the dictionary, we can increase the rate at which ads are matched (the fill rate) and the average price per click (PPC) that the ads yield.

In addition, the present invention enables new forms of advertising that use the notebook system as a delivery mechanism. The first is the Subject Notebook, which provides a collection of relevant editorial content along with a set of advertisements, grouped together on related topics from multiple vendors, and all organized into a notebook. This notebook can be presented to the user as a single result in response to a search query. The notebook can be constructed manually; semi-automatically (by having an editor set up a definition and content is filled in from an advertising database); or fully automatically (using an ontology and an advertising database).

A second form of advertising enabled by the present invention is Sponsored Notebook, which groups together a number of advertisements on related topics from a single vendor, and combines them with related editorial content and offers it to the user as a single result in response to a query. As with Subject Notebooks, Sponsored Notebooks can be constructed manually; semi-automatically; or automatically.

What is claimed is:

1. A computer-implemented method for the gathering, managing and utilization of information from a distributed network of diverse information sources, the method comprising the steps of,
searching across the networked collection of information sources for relevant information;
collecting links to relevant information;
annotating those links with additional information;
organizing those links into an electronic notebook;
accessing the electronic notebook through a user interface on a networked computer or other device;
browsing and/or searching the electronic notebook to retrieve and display saved information; and
configuring the electronic notebook to allow access by other individuals in a shared manner.

2. The method of claim 1 wherein said distributed network is the Internet.

3. The method of claim 1 wherein said distributed network is a Local Area Network.

4. The method of claim 1 wherein said information sources are web sites.

5. The method of claim 1 wherein said information sources are web search engines.

6. The method of claim 1 wherein said relevant information are web pages.

7. The method of claim 1 wherein said relevant information are computer files.

8. The method of claim 1 wherein said relevant information are electronic mail messages.

9. The method of claim 1 wherein said electronic notebook further comprises a collection of hierarchically organized folders and links with associated annotations.

10. The method of claim 1 wherein said user interface is a web application accessed through a web browser.

11. The method of claim 10 wherein said web application is enhanced by a plug-in component added on to the web browser.

12. The method of claim 1 wherein said user interface is a computer program running on a desktop or notebook computer.

13. The method of claim 1 wherein said configuration for sharing further comprises a specification of the portion of the information to be shared, the person or persons with which to share it, and the type of access that person or persons is allowed.

14. A computer-implemented system for the gathering, managing and utilization of information from a distributed network of diverse information sources, the system comprising,
An electronic notebook for storing information; and
A user interface application for creating, accessing and manipulating the electronic notebook.

15. The system of claim 14 wherein said network is the Internet.

16. The system of claim 14 wherein said network is a Local Area Network.

17. The system of claim 14 wherein said information sources are web sites.

18. The system of claim 14 wherein said information sources are web search engines.

19. The system of claim 14 wherein said information are links to web pages.

20. The system of claim 14 wherein said information are links to computer files.

21. The system of claim 14 wherein said information are links to electronic mail messages.

22. The system of claims 19, 20 and 21, said information further comprising annotations added to the links.

23. The system of claim 22, wherein said annotations are notes added by the user consisting of text and/or images.

24. The system of claim 22, wherein said annotations are audio or video files added by the user.

25. The system of claim 22, wherein said annotations are data specifying regions of the information referenced by the link which are to be highlighted.

26. The method of claim 14 wherein said user interface is a web application accessed through a web browser.

27. The method of claim 26 wherein said web application is enhanced by a plug-in component added on to the web browser.

28. The method of claim 14 wherein said user interface is a computer program running on a desktop or notebook computer.

29. The system of claim 14, such electronic notebook further comprising a repository for storing information and a collection of services used by the user interface in accessing the electronic notebook.

30. The system of claim 29, such a collection of services further comprising a computer program running on one or more computer servers and accessed through a network protocol.

31. The system of claim 30, wherein said network protocol is the Simple Object Access Protocol (SOAP).

32. The system of claim 29, wherein said repository is implemented using a conventional relational database management system.

33. The system of claim 29, further comprising the following components: Notebook Manager, Domain Manager, Query Manager, Collaborative Search Engine.

34. The system of claim 33, wherein such Notebook Manager is a computer program providing functions to create, modify, remove, retrieve, index and search an electronic notebook stored in a repository.

35. The system of claim 33, wherein such Domain Manager is a computer program providing an abstract representation of an information source that is available on a network and can be referenced through a network interface.

36. The system of claim 35, such abstraction further comprising a representation of what information is available, how to access the information, and how to query the information.

37. The system of claim 35, further comprising the ability to organize the information retrieved from such an information source into a new or existing electronic notebook.

38. The system of claim 35, wherein such information source is a web site.

39. The system of claim 35, wherein such information source is a web search engine.

40. The system of claim 35, wherein such information source is a computer containing files and/or electronic mail.

41. The system of claim 33, wherein such Query Manager is a computer program providing a facility to automatically save the results of user searches into an electronic note book.

42. The system of claim 33, wherein such Collaborative Search Engine is a computer program providing functions to find information that is relevant to a user query by searching the notebooks of other users for relevant results.

43. The system of claim 14, enhanced by allowing the user interface application to access the electronic notebook from more than one physical computer across a network.

44. The system of claim 43, further allowing a user to specify a portion of the electronic notebook which can be accessed by other users.

45. The system of claim 44 wherein such specification further comprises the part of the electronic notebook to be shared, the users to be allowed access, and the type of access those users should be allowed.

46. A computer-implemented method of delivering advertising to users in conjunction with, and enhanced by the use of an electronic notebook system, comprising the steps of
Providing various locations for displaying advertising;
Providing various means of organizing and constructing the advertisements for display; and
Deciding which advertisements to display to a user in a specific situation.

47. The method of claim 46 wherein said locations further comprise showing advertisements in association with searching an electronic notebook.

48. The method of claim 46 wherein said locations further comprise showing advertisements in association with browsing an electronic notebook.

49. The method of claim 48 where such advertisements are chosen according to how relevant the advertisement is to the content of the electronic notebook being browsed.

50. The method of claim 46 wherein said means of organizing the advertising consists of grouping together a collection of relevant information and a set of advertisements on related topics, organizing into an electronic notebook, and presenting such a notebook to the user.

51. The method of claim 50 wherein said set of advertisements is from multiple advertisers.

52. The method of claim 50 wherein said set of advertisements is from a single advertiser.

53. The method of claim 50 wherein said electronic notebook is presented to the user as a single result in response to a search query.

54. The method of claim 50 wherein said electronic notebook is presented to the user by adding the notebook to the user's set of notebooks.

55. A computer-implemented system for delivering advertising to users in conjunction with, and enhanced by the use of an electronic notebook system, including displaying advertisements to the user and providing a means for organizing the advertisements.

56. The system of claim 55 further comprising the display of advertisements along with the results of searching an electronic notebook.

57. The system of claim 55 further comprising the display of advertisements while browsing an electronic notebook.

58. The system of claim 57 where such advertisements are chosen according to how relevant the advertisement is to the content of the electronic notebook being browsed.

59. The system of claim 55 wherein said means of organizing the advertising consists of grouping together a collection of relevant information and a set of advertisements on related topics, organizing into an electronic notebook, and presenting such a notebook to the user.

60. The system of claim 59 wherein said set of advertisements is from multiple advertisers.

61. The system of claim 59 wherein said set of advertisements is from a single advertiser.

62. The system of claim 59 wherein said electronic notebook is presented to the user as a single result in response to a search query.

63. The system of claim 59 wherein said electronic notebook is presented to the user by adding the notebook to the user's set of notebooks.

64. The system of claim 63 further comprising a user application component that loads an abstract representation of an electronic notebook containing information and/or advertisements from a third-party computer into a notebook system.

65. The system of claim 64 wherein said abstract representation is a computer file containing text in XML format.
